(19) United States
(12) Patent Application Publication
(10) Pub. No.: US 2026/0303322 A1
(43) Pub. Date: Oct. 1, 2026

(54) IMPORT OF ENCRYPTED KEYS TO A SECURE MULTI-PARTY COMPUTATION SYSTEM

(71) Applicant: Coinbase, Inc., Oakland, CA (US)

(72) Inventors: Samuel Ranellucci, Montreal (CA); Yehuda Lindell, Petah Tikva (IL)

(21) Appl. No.: 19/093,000

(22) Filed: Mar. 27, 2025

(51) Int. Cl. H04L 9/08; G06F 21/72

(52) U.S. Cl. CPC H04L 9/0825; G06F 21/72; H04L 9/0861

(57) ABSTRACT

Methods, systems, and devices for data management are described. A first device and a second device may securely import encrypted shares of signing keys to a multi-party computation system. The first device and the second device may execute a secure computation protocol using respective inputs that are not revealed to the other device. The first device may generate and transmit a first public key share and a result of a zero-knowledge proof that the first device possesses a first signing key share. The second device may verify that the first public key share corresponds to the public key and that the result of the zero-knowledge proof is valid. The first device and the second device may output respective signing key shares to respective entities in the multi-party computation system based on the verification by the second device.

### FIELD OF TECHNOLOGY

The present disclosure relates generally to data management, including techniques for import of encrypted keys to a secure multi-party computation (MPC) system.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports import of encrypted keys to a secure multi-party computation (MPC) system in accordance with aspects of the present disclosure.

FIG. 2 shows an example of a two-party computation scheme that supports import of encrypted keys to a secure MPC system in accordance with aspects of the present disclosure.

FIG. 3 shows an example of a process flow that supports import of encrypted keys to a secure MPC system in accordance with aspects of the present disclosure.

FIG. 4 shows a block diagram of an apparatus that supports import of encrypted keys to a secure MPC system in accordance with aspects of the present disclosure.

FIG. 5 shows a block diagram of a client application that supports import of encrypted keys to a secure MPC system in accordance with aspects of the present disclosure.

FIG. 6 shows a diagram of a system including a device that supports import of encrypted keys to a secure MPC system in accordance with aspects of the present disclosure.

FIG. 7 shows a block diagram of an apparatus that supports import of encrypted keys to a secure MPC system in accordance with aspects of the present disclosure.

FIG. 8 shows a block diagram of a client application that supports import of encrypted keys to a secure MPC system in accordance with aspects of the present disclosure.

FIG. 9 shows a diagram of a system including a device that supports import of encrypted keys to a secure MPC system in accordance with aspects of the present disclosure.

FIGS. 10 through 13 show flowcharts illustrating methods that support import of encrypted keys to a secure MPC system in accordance with aspects of the present disclosure.

### DETAILED DESCRIPTION

Computing systems may utilize private keys for various cryptographic operations, such as encryption and signing. To generate such private keys, a first system (e.g., including one or more computing devices) may generate a private key as a random element in a field, such as select a random integer from a set of integers, where the private key is used for encryption (i.e., as an encryption key) or signing (i.e., as a signing key). The first system may encrypt the private key via a symmetric key algorithm to provide improved security (e.g., relative to storing the key in unencrypted form). That is, the first system may encrypt the private key and store the private key in an encrypted form such that, if the private key were to be stolen, the private key would not be revealed in unencrypted form. Additionally, the first system may generate a public key corresponding to the private key by applying the random integer to a generator of a group.

In some cases, cryptographic operations may be implemented using multi-party computation (MPC) techniques, whereby various computing systems perform a cryptographic operation using a share of the private key. In MPC systems, the private key may be split into key shares, which are distributed among multiple computing devices or systems. The MPC system may provide improved security compared to some other systems in which a private key is stored in its entirety, as multiple private key shares would have to be obtained to reconstruct the private key. To support utilization of MPC systems, a system having the encrypted key may import the private key shares to the MPC system. In cases in which the first system stores the private key in an encrypted form, importing the private key to the MPC system may be difficult. For example, the first system may be required to decrypt the private key before importing the private key to the MPC system. Decrypting and transferring the private key may pose security vulnerabilities, as a corrupt party may obtain the private key in decrypted form during the transfer.

Techniques described herein support secure and efficient import of encrypted private keys into an MPC system. To support import, a first party and a second party may perform a secure computation protocol, such as a semi-private secure two-party computation protocol, that ensures accurate output to the MPC system and reduces security vulnerabilities compared to importing the private key in decrypted form in its entirety. The first party and the second party may perform a secure computation protocol to create shares of the private key. The first party and the second party may then verify whether the second party receives a correct output of the secure computation protocol. For example, the first party may generate a first public key share of a public key and a zero-knowledge proof that the first party possesses a first private key share of the private key. The second party may then verify that the first public key share corresponds to the public key and that a result of the zero-knowledge proof is valid. Based on the verification by the second party, the first party and the second party may output their respective private key shares to different entities in the MPC system.

By performing the secure computation protocol, the first party and the second party may ensure that the first share of the private key and the second share of the private key are accurately and securely output to the MPC system. For example, verifying that the second party receives the correct output may ensure that both the first share and the second share of the private key are correct. Additionally, decrypting the shares of the private key, rather than the entire private key, may reduce the likelihood of a corrupt party obtaining the private key in decrypted form. In the secure computation protocol, a corrupt first party may transmit incorrect information to the second party, in which case the protocol is aborted by the second party. However, neither the first party nor the second party may obtain the inputs to the secure computation protocol of the other and, therefore, neither party may reconstruct the private key in its entirety in decrypted form. In other words, neither party in the protocol may cheat and recover the entire, decrypted private key. Additionally, the protocol described herein may minimize use of computing resources compared to other private key importing mechanisms, as the secure computation protocol may involve minimal round complexity (e.g., relatively few rounds of verification, communication between devices, etc.). These and other techniques are described in further detail with respect to the figures.

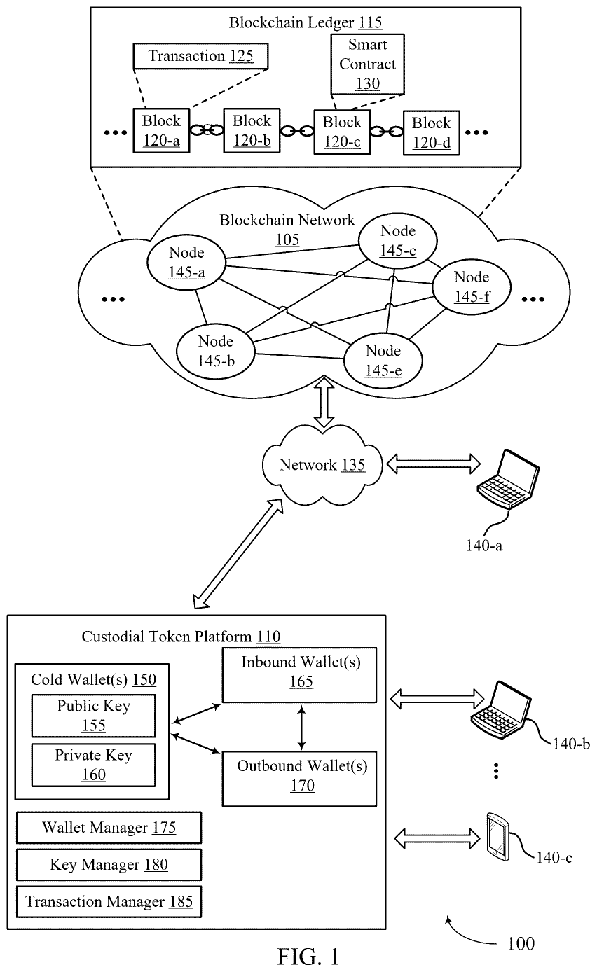

FIG. 1 illustrates an example of a computing environment 100 that supports import of encrypted keys to a secure MPC system in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

The blockchain network 105 and/or the custodial token platform 110 may implement an MPC system for improved security. For example, the custodial token platform 110 may implement an MPC system for improved security for cold storage (e.g., the cold wallet 150). Multiple computing devices may be part of an MPC system in which a private key is distributed as shares or shards across the computing devices. The computing devices may, according to an MPC protocol, perform operations using the respective private key shares. As an example, each computing device may use their respective private key share of the private key to generate a partial signature for a message broadcast via the blockchain network 105, where a threshold quantity of partial signatures are required to verify and store the message on the blockchain ledger 115 of the blockchain network 105. In other words, the computing devices may be part of a threshold signing scheme (TSS). Additionally, or alternatively, the MPC system may perform encryption. For example, the private key may be an example of an encryption key used to encrypt data.

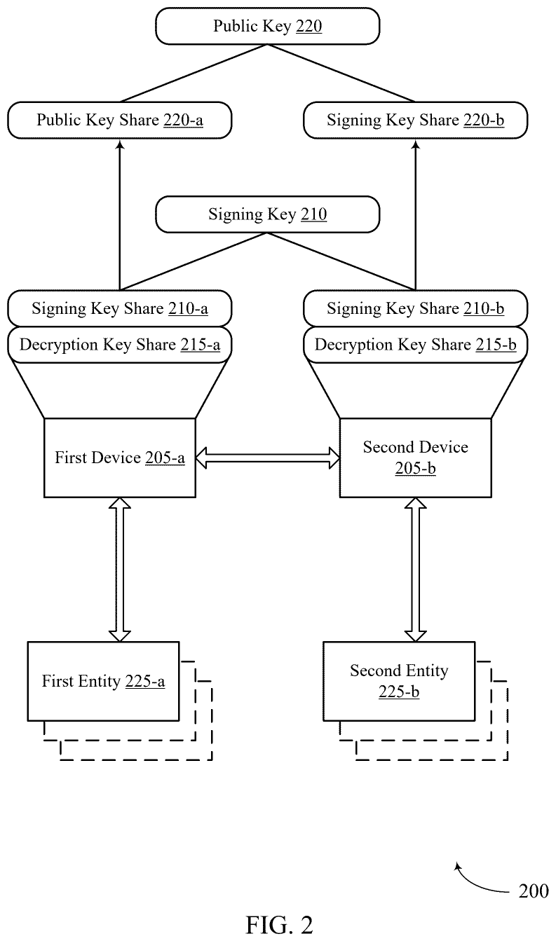

FIG. 2 shows an example of a secure two-party computation scheme 200 that supports import of encrypted keys to a secure MPC system in accordance with aspects of the present disclosure. The secure two-party computation scheme 200 may implement or be implemented by aspects of the computing environment 100. For example, the first device 205-a and the second device 205-b may import share(s) of signing keys to the first entity 225-a and the second entity 225-b, respectively. The first entity 225-a and the second entity 225-b may be examples of parties in an MPC system. For example, the first entity 225-a and the second entity 225-b may, via a MPC scheme and using the respective signing key shares, generate a signature (e.g., for a transaction on a blockchain network, such as the blockchain network 105 as described with reference to FIG. 1) or perform encryption. The first entity 225-a and the second entity 225-b may be examples of computing devices or computing systems.

The first device 205-a and the second device 205-b may be examples of a first party and a second party, respectively, in the secure two-party computation scheme 200. In the example of FIG. 2, the first device 205-a may be the “sender” in the scheme, while the second device 205-b may be the “receiver” in the scheme.

Each party Pᵢ in the secure two-party computation scheme 200 may hold XOR-shares kᵢ of the symmetric encryption scheme. For example, the first device 205-a may hold a decryption key share 215-a (e.g., k₁) and the second device 205-b may hold a decryption key share 215-b (e.g., k₂). Each party may) know the public key 220 (e.g., Q), as well as a ciphertext c that encrypts ) the signing key 210 (e.g., x) such that Q=x·G. The public key 220 may be a publicly agreed-upon generator of a group (e.g., a group involved in generation of the signing key 210).

The first device 205-a and the second device 205-b may perform a semi-private secure computation protocol. The first device 205-a (e.g., the sender) may have a private input (e.g., private from the second device 205-b) of the signing key share 210-a and the decryption key share 215-a. The second device 205-b (e.g., the receiver) may have a private input (e.g., private from the first device 205-a) of the decryption key share 215-b. The first device 205-a and the second device 205-b may have a public input of the ciphertext c, where the ciphertext c is an encryption of the signing key 210. The second device 205-b may receive, as an output of the semi-private secure computation protocol, the signing key share 210-b. For example, the semi-private secure computation protocol may be expressed as x₂←Decₖ_{₁}_{⊕k}_{₂}(c)−x₁, where only the second device 205-b receives the signing key share 210-b, and where neither device sees the other's private inputs. In some cases, the techniques described herein may support generation of private key shares based on seeds. In such cases, the ciphertext c may be an encryption of the seed used to generate the signing key 210 instead of the signing key 210.

The secure computation protocol may be “semi-private” by meeting the following properties:
1. The secure computation protocol is secure against a corrupt receiver.
2. The execution of the secure computation protocol reveals no information about the receiver's input to the sender.

In other words, the secure computation protocol may be secure if the second device 205-b is corrupt. Additionally, the second device 205-b may perform the secure computation protocol without revealing information about the inputs of the second device 205-b to the first device 205-a. The semi-private secure computation protocol may allow the first device 205-a (e.g., P₁) to choose a random share of the signing key 210 (e.g., the signing key share 210-a x₁) and for the second device 205-b (e.g., P₂) to learn a signing key share 210-b (e.g., x₂) such that the signing key share 210-a and the signing key share 210-b correspond to the signing key 210 (i.e., such that x₁+x₂=x where x is the signing key). In some examples, since the selection and output of the respective signing key shares involves the use of a semi-private protocol, a malicious sender (e.g., the first device 205-a) may make it so that instead of learning the correct signing key share 210-b (e.g., x₂), the second device 205-b instead learns a different value that may allow the first device 205-a to learn significant information about the private key. For example, the malicious sender may modify the function so that v·G reveals bits about x, where v is the second value reconstructed by the second party. Accordingly, the first device 205-a and the second device 205-b may perform verification operations to ensure that the second device 205-b received a correct output from the semi-private secure computation protocol. In other words, the second device 205-b may perform verification to ensure that the only value that P₂ will accept is x₂ such that x₁+x₂=x and x₁ is known by P₁.

For example, the secure two-party computation scheme 200 may implement share verifiability. Share verifiability may refer to a property by which, assuming that a public key Q=x·G is publicly known by both P₁ and P₂ and that a party P₁ has proven to P₂ that they know an x₁ such that Q₁=x₁·G, then P₂ can check that their share x₂ of x is correct by checking that Q₁+x₂·G=Q. Put another way, the first device 205-a (e.g., P₁) and the second device 205-b (e.g., P₂) may each know a public key 220 (e.g., Q), where the public key 220 corresponds to a product of the signing key 210 (e.g., x) and a generator function (e.g., G). The first device 205-a may prove to the second device 205-b that the first device 205-a possesses (e.g., knows) the signing key share 210-a (e.g., x₁) such that a public key share 220-a (e.g., Q₁) equals a product of the signing key share 210-a and the generator function. The second device 205-b may check that a signing key share 210-b of the signing key 210 is correct by checking that a summation of a public key share 220-a (e.g., Q₁) and a product of the signing key share 210-b and the generator function equals the public key 220.

To implement share verifiability, after the second device 205-b obtains the signing key share 210-b via the semi-private secure two-party computation protocol, the first device 205-a and the second device 205-b may verify that the second device 205-b received the correct output (i.e., that the signing key share 210-b is a valid share of the signing key 210). For example, the first device 205-a may set a public key share 220-a as a product of the signing key share 210-a and the generator function G (i.e., set Q₁←x₁·G). The first device 205-a may generate a zero-knowledge proof that the first device 205-a knows the signing key share 210-a such that the public key share 220-a corresponds to a product of the signing key share 210-a and the generator function G (e.g., prove that they know x₁ such that Q₁=x₁·G). A result of the proof, π₁, may prove that the first device 205-a knows the signing key share 210-a without revealing any information about the signing key share 210-a.

The first device 205-a may send information indicative of the public key share 220-a and the result of the proof π₁ to the second device 205-b. In some examples, the first device 205-a may send the public key share 220-a to the second device 205-b. Alternatively, the first device 205-a may determine the public key share 220-b based on the public key 220 and the public key share 220-a (e.g., Q₂=Q−Q₁) and transmit the public key share 220-b to the second device 205-b. In such examples, the second device 205-b may calculate the public key share 220-a from the public key 220 and the public key share 220-b (e.g., Q₁=Q−Q₂).

The second device 205-b may verify that the public key 220 corresponds to a summation of the public key share 220-a and a product, the product being of the signing key share 210-b and the generator function G. That is, the second device 205-b may verify that Q=Q₁+x₂·G. Additionally, the second device 205-b may verify that the result of the proof π₁ is valid. For example, the second device 205-b may verify that the result of the proof π₁ is a valid proof of knowledge that the first device 205-a knows the signing key share 210-a such that the public key share 220-a corresponds to a product of the signing key share 210-a and the generator function G. Put another way, the second device 205-b may verify that π₁ is a valid zero-knowledge proof of knowledge that the first device 205-a knows x₁ such that Q₁=x₁·G. The second device 205-b may abort the procedure if either of the verifications fail. Additionally, or alternatively, the verification may be performed by the second device 205-b by hashing one or more public keys and verifying that the hashes match. For example, the first device 205-a may output a hash of a public key to the second device 205-b. The second device 205-b may generate a corresponding hash of the public key and determine whether the hashes match to perform the verification.

After the first device 205-a and the second device 205-b verify that the second device 205-b obtains a correct output from the semi-private secure computation protocol, the first device 205-a may output the signing key share 210-a to the first entity 225-a and the second device 205-b may output the signing key share 210-b to the second entity 225-b. The first entity 225-a and the second entity 225-b may be examples of devices or systems in an MPC system.

In some examples, the first entity 225-a, the second entity 225-b, or both may include more than one entity. As an example, the first device 205-a may output the signing key share 210-a to a first subset of entities or devices in the MPC system, the first subset including one or more first entities. That is, the first device 205-a may split the signing key share 210-a such that the signing key share 210-a is distributed to the one or more first entities included in the first subset of entities or devices in the MPC system. Similarly, the second device 205-b may output the signing key share 210-b to a second subset of entities or devices in the MPC system, the second subset including one or more second entities. The second device 205-b may split the signing key share 210-b such that the signing key share 210-b is distributed to the one or more second entities included in the second subset of entities or devices in the MPC system.

In some examples, the secure semi-private computation protocol may be realized using garbled circuits. A garbled circuit is a tool that involves a sender (e.g., the first device 205-a) and a receiver (e.g., the second device 205-b), where the sender and receiver each have their own private input, and where the public input is a function of their private inputs. In the example of FIG. 2, the private input of the first device 205-a may be the signing key share 210-a and the decryption key share 215-a, and the private input of the second device 205-b may be the decryption key share 215-b. The public input may be the public key 220 and the ciphertext c that encrypts the signing key 210. Garbled circuits may allow the sender to encrypt a function of their choice and to encrypt their private input. Additionally, garbled circuits may allow the receiver to learn an encryption of their own input such that when the receiver is provided the encrypted function, the encryption of the sender's input, and an encryption of their own input, the receiver is able to learn the output of the function chosen by the sender and is not able to learn additional information. A secure semi-private computation protocol may implement garbled circuits by having the sender send the encrypted function and their own encrypted input and allowing the receiver to learn an encryption of their own input. This protocol may be semi-private since the receiver may not cheat and the sender cannot gain information in the execution.

The secure semi-private computation protocol may involve input enforcement. For example, the input enforcement may ensure that the same input is used in multiple garbled circuits. That is, the input enforcement may ensure that the decryption key share 215-a and the decryption key share 215-b are correct by using a single ciphertext c and the public key 220 of the keypair to check that a correct encryption key is used.

The techniques described herein may be applied in examples in with the ciphertext c is split into shares. For example, the ciphertext c may be split into shares c₁ and c₂ by sending each share cᵢ to the player Pᵢ. That is, the first device 205-a may receive a first ciphertext share c₁, and the second device 205-b may receive a second ciphertext share c₂. In such examples, the private inputs to the secure computation protocol may be modified such that each player Pᵢ also inputs cᵢ and by modifying the output of the semi-private secure computation to produce x₂←Decₖ_{₁}_{⊕k}_{₂}(c₁⊕c₂)−x₁ instead of x₂←Decₖ_{₁}_{⊕k}_{₂}(c)−x₁.

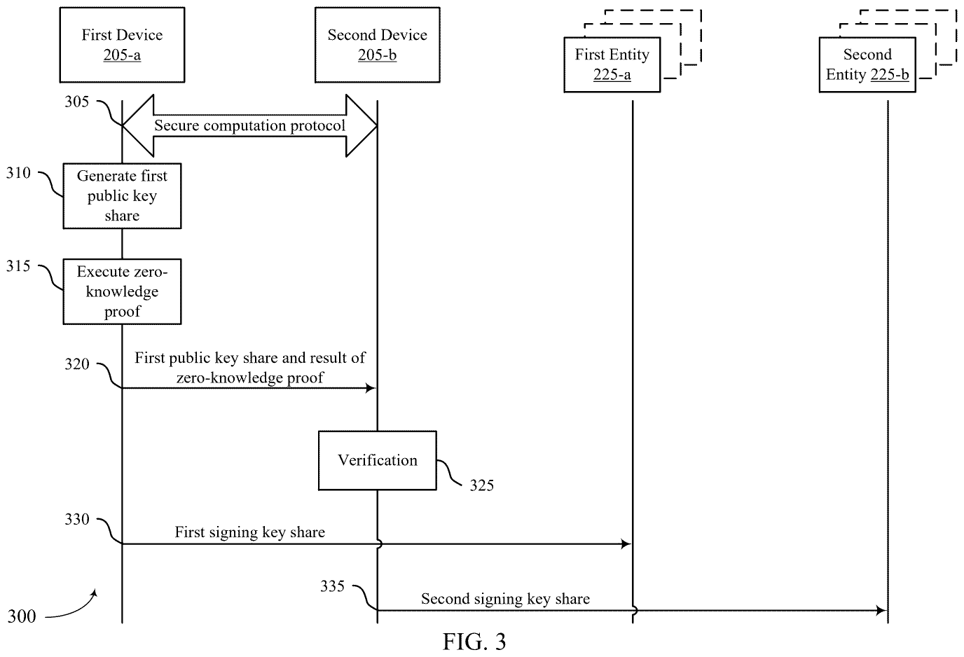

FIG. 3 shows an example of a process flow 300 that supports import of encrypted keys to a secure MPC system in accordance with aspects of the present disclosure. The process flow 300 may implement or be implemented by the computing environment 100, the secure two-party computation scheme 200, or both. For example, the process flow 300 may include a first device 205-a, a second device 205-b, a first entity 225-a, and a second entity 225-b, which may be examples of corresponding devices as described with reference to FIG. 2.

Alternative examples of the following may be implemented, where some operations are performed in a different order than described or are not performed at all. In some examples, operations may include additional features not mentioned below, or further operations may be added. Although the first device 205-a, the second device 205-b, the first entity 225-a, and the second entity 225-b are shown performing the operations of the process flow 300, some aspects of some operations may also be performed by one or more other components.

At 305, the first device 205-a and the second device 205-b may perform a secure computation protocol. For example, the first device 205-a may execute, with a second device 205-b, a secure computation protocol that uses an input of a first decryption key share (e.g., k₁) of a decryption key, a first signing key share (e.g., x₁) of a signing key, and a ciphertext (e.g., c) corresponding to an encryption of the signing key. The second device 205-b may execute, with the first device 205-a, the secure computation protocol that uses an input of a second decryption key share (e.g., k₂) of a decryption key and a ciphertext corresponding to an encryption of a signing key. Execution of the secure computation protocol may result in output, to the second device 205-b, of a second signing key share (e.g., x₂) of the signing key.

The first decryption key share, the first signing key share, the signing key, the second decryption key share, and the second signing key share may be examples of corresponding elements as described with reference to FIG. 2.

The secure computation protocol may be an example of a semi-private secure computation protocol. The semi-private secure computation protocol may be secure against the second device 205-b that is to receive the second signing key share. That is, the semi-private secure computation protocol may be secure against a corrupt receiver in the protocol (e.g., where the first device 205-a is the sender and the second device 205-b is the receiver in the example of FIGS. 2 and 3). Additionally, the semi-private secure computation protocol may not reveal information about the input of the second device 205-b (e.g., the receiver) to the first device 205-a (e.g., the sender). For example, the execution of the secure computation protocol may not reveal any information about the second decryption key share of the decryption key or the second signing key share of the signing key to the first device 205-a.

In some examples, the secure computation protocol may use garbled circuits. Additionally, the secure computation protocol may involve applying an input enforcement to the secure computation protocol, the input enforcement including use of the ciphertext and the public key to verify whether an encryption key was used to generate the ciphertext corresponding to the encryption of the signing key. That is, the first device 205-a and the second device 205-b may ensure that the same input is used in multiple garbled circuits by using a single ciphertext and public key pair to check that the correct encryption key is used.

In some aspects, the ciphertext may be split into shares. In such examples, the first device 205-a may input a first ciphertext share (e.g., c₁) and the second device 205-b may input a second ciphertext share (e.g., c₂) to the secure computation protocol. When using the ciphertext shares, the semi-private secure computation may produce x₂←Decₖ_{₁}_{⊕k}_{₂}(c₁⊕c₂)−x₁ (e.g., instead of x₂←Decₖ_{₁}_{⊕k}_{₂}(c)−x₁).

At 310, the first device 205-a may generate a first public key share. For example, the first device 205-a may generate a first public key share (e.g., Q₁) of a public key based on the first signing key share of the signing key (or a seed used to generate the first signing key share) and a generator function. Put another way, the first device 205-a may set Q₁←x₁·G. The first public key share may be an example of the public key share 220-a as described with reference to FIG. 2.

At 315, the first device 205-a may execute a zero-knowledge proof. For example, the first device 205-a may execute a zero-knowledge proof that the first device 205-a possesses the first signing key share of the signing key such that the first public key share of the public key corresponds to a product of the first signing key share of the signing key and the generator function. Put another way, the first device 205-a may generate a zero-knowledge proof that the first device 205-a knows x₁ such that Q₁=x₁·G. Execution of zero-knowledge proof may produce a result, such as π₁. The result may not reveal any information about the inputs of the first device 205-a to the secure computation protocol (e.g., not reveal k₁ and/or x₁).

At 320, the first device 205-a may transmit a first public key share and a result of the zero-knowledge proof to the second device 205-b. For example, the first device 205-a may transmit information indicative of the first public key share of the public key and the result of execution of the zero-knowledge proof to the second device 205-b. In some examples, the information indicative of the first public key share may be the first public key share itself, or a second public key share that may be used to calculate the first public key share. For example, the information indicative of the first public key share may be Q₂ such that the second device 205-b may determine the first public key share as Q₁=Q−Q₂.

At 325, the second device 205-b may perform verification. In a first verification, the second device 205-b may verify that the public key is equal to a summation of the first public key share and a first product, the first product being of the second signing key share of the signing key and a generator function. That is, the second device 205-b may verify that Q=Q₁+x₂·G. In a second verification, the second device 205-b may verify that the result of the execution of the zero-knowledge proof is valid such that the first public key share corresponds to a second product, the second product being of a first signing key share of the signing key and the generator function. Put another way, the second device 205-b may verify that π₁ is a valid zero-knowledge proof of knowledge that the first device 205-a knows x₁ such that Q₁=x₁·G.

Additionally, or alternatively, at 320, the first device 205-a may hash the first public key share, and output the hash of the public key share to the second device 205-b. In such cases, to perform the verification, the second device 205-b may generate a hash of the public key share, and verify that the hash received from the first device 205-a matches the hash generated by the second device 205-b. The second device 205-b may abort the secure computation protocol if the first verification or the second verification fail. That is, the second device 205-b may refrain from outputting the second signing key share to the second entity 225-b at 335 if either or both of the first verification and the second verification fail.

At 330, the first device 205-a may output a first signing key share to the first entity 225-a. For example, the first device 205-a may output the first signing key share of the signing key to the first entity 225-a based on a verification by the second device 205-b involving the first public key share of the public key and the result of the execution of the zero-knowledge proof. That is, the first device 205-a may output the first signing key share based on successful verification by the second device 205-b at 325.

At 335, the second device 205-b may output a second signing key share to the second entity 225-b. For example, the second device 205-b may output the second signing key share of the signing key to the second entity 225-b based on verifying that the public key is equal to the summation and on verifying that the result of the execution of the zero-knowledge proof is valid (e.g., based on the verification at 325).

In some aspects, the signing key may be associated with a blockchain wallet. For example, the first entity 225-a and the second entity 225-b may use the respective shares of the signing key to perform operations on the blockchain network. As one example, the first entity 225-a and the second entity 225-b may sign a blockchain transaction to transfer a crypto token from a blockchain address of the blockchain wallet to another blockchain address.

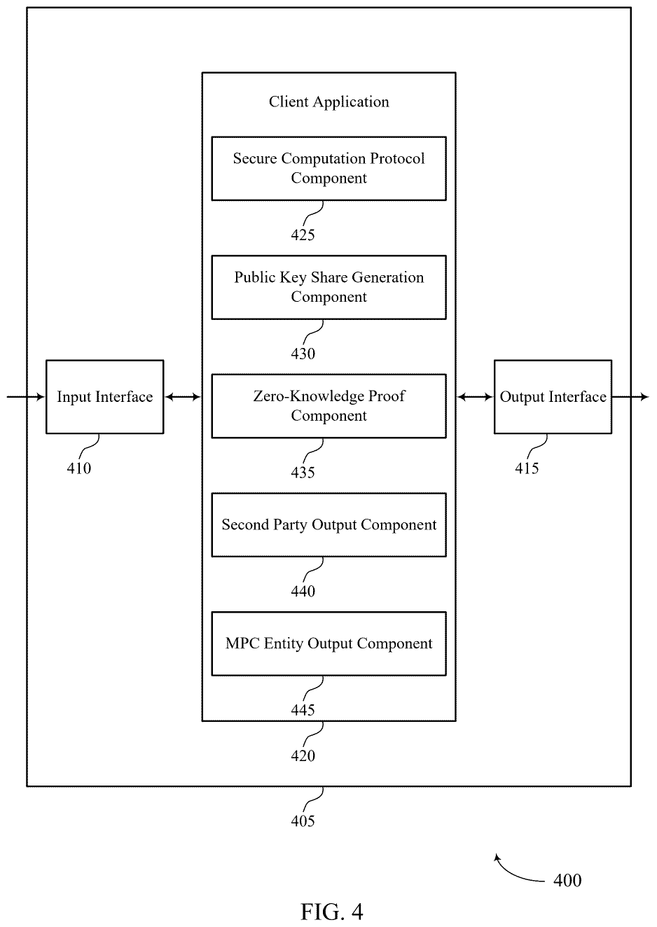

FIG. 4 shows a block diagram 400 of a device 405 that supports import of encrypted keys to a secure MPC system in accordance with aspects of the present disclosure. The device 405 may include an input interface 410, an output interface 415, and a client application 420. The device 405, or one or more components of the device 405 (e.g., the input interface 410, the output interface 415, the client application 420), may include at least one processor, which may be coupled with at least one memory, to support the described techniques. Each of these components may communicate, directly or indirectly, with one another (e.g., via one or more buses, communications links, communications interfaces, or any combination thereof).

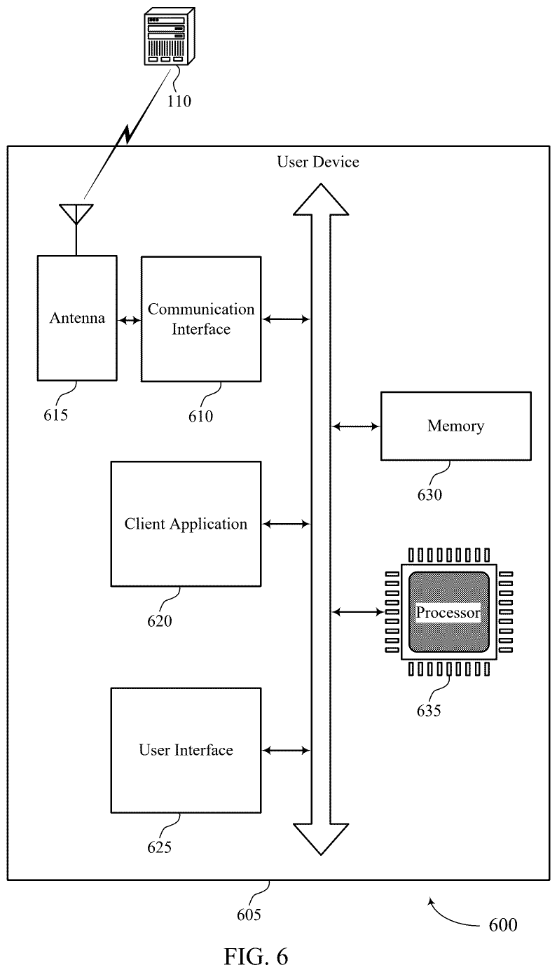

The input interface 410 may manage input signaling for the device 405. For example, the input interface 410 may receive input signaling (e.g., messages, packets, data, instructions, commands, transactions, or any other form of encoded information) from other systems or devices. The input interface 410 may send signaling corresponding to (e.g., representative of or otherwise based on) such input signaling to other components of the device 405 for processing. For example, the input interface 410 may transmit such corresponding signaling to the client application 420 to support publicly verifiable encrypted signatures. In some cases, the input interface 410 may be a component of a communication interface 610 as described with reference to FIG. 6.

The output interface 415 may manage output signaling for the user device 405. For example, the output interface 415 may receive signaling from other components of the user device 405, such as the input interface 410, and may transmit such output signaling corresponding to (e.g., representative of or otherwise based on) such signaling to other systems or devices. In some cases, the output interface 415 may be a component of a communication interface 610 as described with reference to FIG. 6.

For example, the client application 420 may include a secure computation protocol component 425, a public key share generation component 430, a zero-knowledge proof component 435, a second party output component 440, an MPC entity output component 445, or any combination thereof. In some examples, the client application 420, or various components thereof, may be configured to perform various operations (e.g., receiving, monitoring, transmitting) using or otherwise in cooperation with the input interface 410, the output interface, or both. For example, the client application 420 may receive information from the input interface 410, send information to the output interface 415, or be integrated in combination with the input interface 410, the output interface 415, or both to receive information, transmit information, or perform various other operations as described herein.

The secure computation protocol component 425 may be configured as or otherwise support a means for executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key. The public key share generation component 430 may be configured as or otherwise support a means for generating a first public key share of a public key based at least in part on the first signing key share of the signing key and a generator function. The zero-knowledge proof component 435 may be configured as or otherwise support a means for executing a zero-knowledge proof that the first device possesses the first signing key share of the signing key such that the first public key share of the public key corresponds to a product of the first signing key share of the signing key and the generator function. The second party output component 440 may be configured as or otherwise support a means for transmitting information indicative of the first public key share of the public key and a result of execution of the zero-knowledge proof to the second device. The MPC entity output component 445 may be configured as or otherwise support a means for outputting the first signing key share of the signing key to an entity based at least in part on a verification by the second device involving the first public key share of the public key and the result of the execution of the zero-knowledge proof.

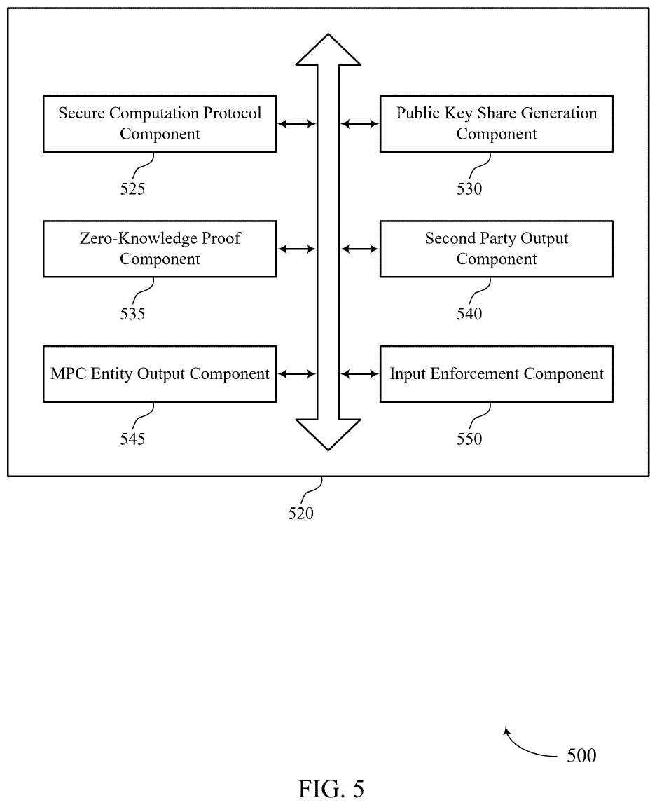

FIG. 5 shows a block diagram 500 of a client application 520 that supports import of encrypted keys to a secure MPC system in accordance with aspects of the present disclosure. The client application 520 may be an example of aspects of a client application or a client application 420, or both, as described herein. The client application 520, or various components thereof, may be an example of means for performing various aspects of import of encrypted keys to a secure MPC system as described herein. For example, the client application 520 may include a secure computation protocol component 525, a public key share generation component 530, a zero-knowledge proof component 535, a second party output component 540, an MPC entity output component 545, an input enforcement component 550, or any combination thereof. Each of these components may communicate, directly or indirectly, with one another (e.g., via one or more buses, communications links, communications interfaces, or any combination thereof).

The secure computation protocol component 525 may be configured as or otherwise support a means for executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key. The public key share generation component 530 may be configured as or otherwise support a means for generating a first public key share of a public key based at least in part on the first signing key share of the signing key and a generator function. The zero-knowledge proof component 535 may be configured as or otherwise support a means for executing a zero-knowledge proof that the first device possesses the first signing key share of the signing key such that the first public key share of the public key corresponds to a product of the first signing key share of the signing key and the generator function. The second party output component 540 may be configured as or otherwise support a means for transmitting information indicative of the first public key share of the public key and a result of execution of the zero-knowledge proof to the second device. The MPC entity output component 545 may be configured as or otherwise support a means for outputting the first signing key share of the signing key to an entity based at least in part on a verification by the second device involving the first public key share of the public key and the result of the execution of the zero-knowledge proof.

In some examples, the secure computation protocol comprises a garbled circuit.

In some examples, the input enforcement component 550 may be configured as or otherwise support a means for applying an input enforcement to the secure computation protocol, the input enforcement comprising use of the ciphertext and the public key to verify whether an encryption key was used to generate the ciphertext corresponding to the encryption of the signing key.

In some examples, the ciphertext comprises a first ciphertext share associated with the first device and a second ciphertext share associated with the second device.

In some examples, the secure computation protocol is secure against the second device that is to receive the second signing key share.

In some examples, the secure computation protocol involves two parties. In some examples, a first party of the two parties is associated with the first device and a second party of the two parties is associated with the second device.

In some examples, the signing key is associated with a blockchain wallet.

In some examples, the information indicative of the first public key share of the public key comprises the first public key share or a second public key share of the public key, the public key comprising the first public key share and the second public key share.

FIG. 6 shows a diagram of a system 600 including a device 605 that supports import of encrypted keys to a secure MPC system in accordance with aspects of the present disclosure. The device 605 may be an example of or include components of a device 405 as described herein. The device 605 may include components for importing encrypted keys to a secure MPC system, such as including a client application 620, a communication interface 610, one or more antennas 615, a user interface component 625, at least one memory 630, and at least one processor 635. Each of these components may communicate, directly or indirectly, with one another (e.g., via one or more buses, communications links, communications interfaces, or any combination thereof).

The communication interface 610 may manage input and output signals for the device 605 via the antenna 615. For example, the communication interface 610 may enable the user device 605 to exchange information (e.g., input information, output information, or both) with other systems or devices, such as custodial token platform 110 (e.g., supported by one or more servers), via one or more wired or wireless communication links. The communication interface 610 may also utilize or interact with antenna 615 to support communication with other systems or devices. In some cases, the communication interface 610 may represent a physical connection or port to an external peripheral, such as a hardware wallet device. In some cases, the communication interface 610 may utilize an operating system such as iOS®, ANDROID®, MS-DOS®, MS-WINDOWS®, OS/2®, UNIX®, LINUX®, or another known operating system. The communication interface 610 may be implemented as part of the processor 635.

In some cases, the device 605 may include a single antenna 615. However, in some other cases, the device 605 may have more than one antenna 615, which may be capable of concurrently transmitting or receiving multiple wireless transmissions. The communication interface 610 may communicate bi-directionally, via the one or more antennas 615, wired, or wireless links as described herein. For example, the communication interface 610 may represent a wireless transceiver and may communicate bi-directionally with another wireless transceiver. The communication interface 610 may also include a modem to modulate the packets, to provide the modulated packets to one or more antennas 615 for transmission, and to demodulate packets received from the one or more antennas 615.

The user interface component 625 may represent a keyboard, a mouse, a touchscreen, a microphone, or a similar device or component. In some cases, a user may interact with the user interface component 625. In other cases, the user interface component 625 may operate automatically without user interaction. The user interface component 625 may display or output information such as information received from other systems or devices or information to be transmitted to other systems or devices.

The memory 630 may include RAM and ROM. The memory 630 may store computer-readable, computer-executable software including instructions that, when executed, cause at least one processor 635 to perform various functions described herein. In some cases, the memory 630 may contain, among other things, a BIOS which may control basic hardware or software operation such as the interaction with peripheral components or devices. The memory 630 may be an example of a single memory or multiple memories. For example, the user device 605 may include one or more memories 630.

The processor 635 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 635 may be configured to operate a memory array using a memory controller. In other cases, a memory controller may be integrated into the processor 635. The processor 635 may be configured to execute computer-readable instructions stored in at least one memory 630 to perform various functions (e.g., functions or tasks supporting a method and system for import of encrypted keys to a secure MPC system). Though a single processor 635 is depicted in the example of FIG. 6, it is to be understood that the user device 605 may include any quantity of one or more of processors 635 and that a group of processors 635 may collectively perform one or more functions ascribed herein to a processor, such as the processor 635. The processor 635 may be an example of a single processor or multiple processors. For example, the device 605 may include one or more processors 635.

For example, the client application 620 may be configured as or otherwise support a means for executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key. The client application 620 may be configured as or otherwise support a means for generating a first public key share of a public key based at least in part on the first signing key share of the signing key and a generator function. The client application 620 may be configured as or otherwise support a means for executing a zero-knowledge proof that the first device possesses the first signing key share of the signing key such that the first public key share of the public key corresponds to a product of the first signing key share of the signing key and the generator function. The client application 620 may be configured as or otherwise support a means for transmitting information indicative of the first public key share of the public key and a result of execution of the zero-knowledge proof to the second device. The client application 620 may be configured as or otherwise support a means for outputting the first signing key share of the signing key to an entity based at least in part on a verification by the second device involving the first public key share of the public key and the result of the execution of the zero-knowledge proof.

By including or configuring the client application 620 in accordance with examples as described herein, the device 605 may support techniques for improved security when importing signing keys to an MPC scheme.

The client application 620 may include an application (e.g., “app”), program, software, extension, or other component which is configured to facilitate communications with a custodial token platform 110 on a server, one or more nodes of a blockchain network 105, other user devices 605, and other devices or systems. For example, the client application 620 may be an application executable on the user device 605, and the client application 620 may be configured to receive data from a custodial token platform 110, transmit data to the custodial token platform 110, process such data, and cause presentation of such data to a user via a user interface component 625. The client application 620 may be an example of a wallet application, a wallet device, or both, and may be associated with a wallet address and may access or use a private key to sign messages to facilitate transfer of crypto tokens, messages, transactions, or the like via a blockchain distributed data store.

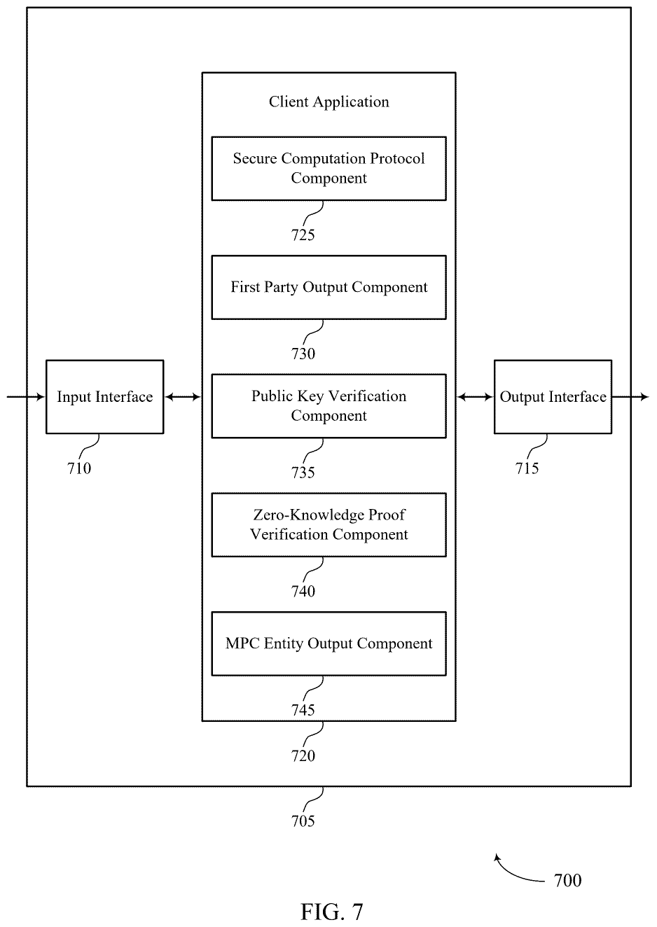

FIG. 7 shows a block diagram 700 of a device 705 that supports import of encrypted keys to a secure MPC system in accordance with aspects of the present disclosure. The device 705 may include an input interface 710, an output interface 715, and a client application 720. The device 705, or one or more components of the device 705 (e.g., the input interface 710, the output interface 715, the client application 720), may include at least one processor, which may be coupled with at least one memory, to support the described techniques. Each of these components may communicate, directly or indirectly, with one another (e.g., via one or more buses, communications links, communications interfaces, or any combination thereof).

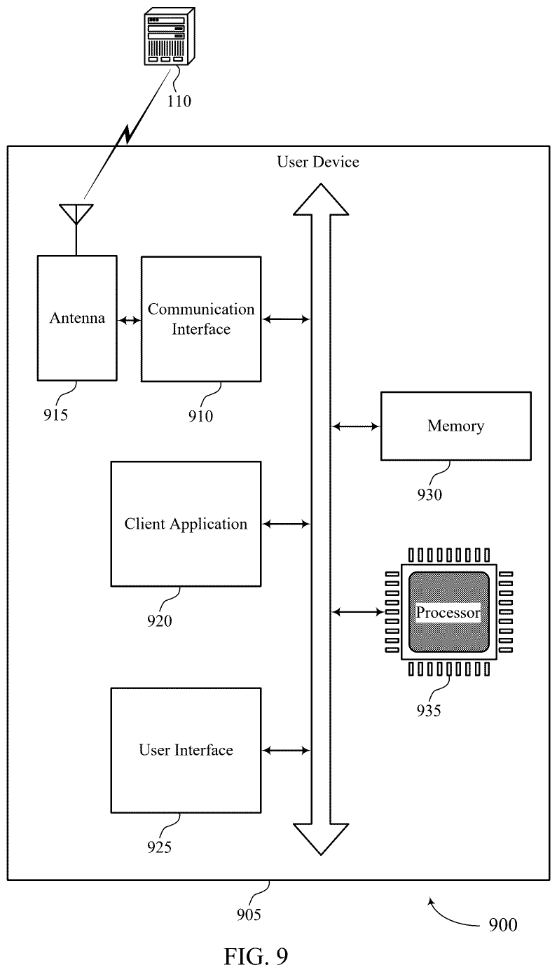

The input interface 710 may manage input signaling for the user device 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the user device 705 for processing. For example, the input interface 710 may transmit such corresponding signaling to the client application 720 to support import of encrypted keys to a secure MPC system. In some cases, the input interface 710 may be a component of a 910 as described with reference to FIG. 9.

The output interface 715 may manage output signaling for the user device 705. For example, the output interface 715 may receive signaling from other components of the user device 705, such as the input interface 710, and may transmit such output signaling corresponding to (e.g., representative of or otherwise based on) such signaling to other systems or devices. In some cases, the output interface 715 may be a component of a communication interface 910 as described with reference to FIG. 9.

For example, the client application 720 may include a secure computation protocol component 725, a first party output component 730, a public key verification component 735, a zero-knowledge proof verification component 740, an MPC entity output component 745, or any combination thereof. In some examples, the client application 720, or various components thereof, may be configured to perform various operations (e.g., receiving, monitoring, transmitting) using or otherwise in cooperation with the input interface 710, the output interface 715, or both. For example, the client application 720 may receive information from the input interface 710, send information to the output interface 715, or be integrated in combination with the input interface 710, the output interface 715, or both to receive information, transmit information, or perform various other operations as described herein.

The secure computation protocol component 725 may be configured as or otherwise support a means for executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key. The first party output component 730 may be configured as or otherwise support a means for receiving information indicative of a first public key share of a public key and a result of an execution of a zero-knowledge proof from the first device. The public key verification component 735 may be configured as or otherwise support a means for verifying that the public key is equal to a summation of the first public key share and a first product, the first product being of the second signing key share of the signing key and a generator function. The zero-knowledge proof verification component 740 may be configured as or otherwise support a means for verifying that the result of the execution of the zero-knowledge proof is valid such that the first public key share corresponds to a second product, the second product being of a first signing key share of the signing key and the generator function. The MPC entity output component 745 may be configured as or otherwise support a means for outputting the second signing key share of the signing key to an entity based at least in part on verifying that the public key is equal to the summation and on verifying that the result of the execution of the zero-knowledge proof is valid.

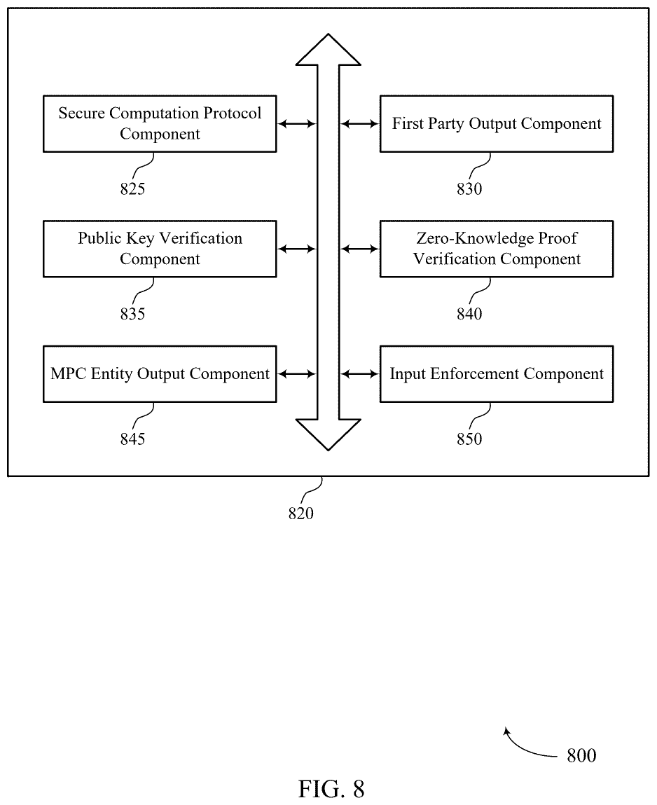

FIG. 8 shows a block diagram 800 of a client application 820 that supports import of encrypted keys to a secure MPC system in accordance with aspects of the present disclosure. The client application 820 may be an example of aspects of a client application or a client application 720, or both, as described herein. The client application 820, or various components thereof, may be an example of means for performing various aspects of import of encrypted keys to a secure MPC system as described herein. For example, the client application 820 may include a secure computation protocol component 825, a first party output component 830, a public key verification component 835, a zero-knowledge proof verification component 840, an MPC entity output component 845, an input enforcement component 850, or any combination thereof. Each of these components may communicate, directly or indirectly, with one another (e.g., via one or more buses, communications links, communications interfaces, or any combination thereof).

The secure computation protocol component 825 may be configured as or otherwise support a means for executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key. The first party output component 830 may be configured as or otherwise support a means for receiving information indicative of a first public key share of a public key and a result of an execution of a zero-knowledge proof from the first device. The public key verification component 835 may be configured as or otherwise support a means for verifying that the public key is equal to a summation of the first public key share and a first product, the first product being of the second signing key share of the signing key and a generator function. The zero-knowledge proof verification component 840 may be configured as or otherwise support a means for verifying that the result of the execution of the zero-knowledge proof is valid such that the first public key share corresponds to a second product, the second product being of a first signing key share of the signing key and the generator function. The MPC entity output component 845 may be configured as or otherwise support a means for outputting the second signing key share of the signing key to an entity based at least in part on verifying that the public key is equal to the summation and on verifying that the result of the execution of the zero-knowledge proof is valid.

In some examples, the secure computation protocol comprises a garbled circuit.

In some examples, the input enforcement component 850 may be configured as or otherwise support a means for applying an input enforcement to the secure computation protocol, the input enforcement comprising use of the ciphertext and the public key to verify whether an encryption key was used to generate the ciphertext corresponding to the encryption of the signing key.

In some examples, the ciphertext comprises a first ciphertext share associated with the first device and a second ciphertext share associated with the second device.

In some examples, the execution of the secure computation protocol does not reveal any information about the second decryption key share of the decryption key or the second signing key share of the signing key to the first device.

In some examples, the secure computation protocol involves two parties. In some examples, a first party of the two parties is associated with the first device and a second party of the two parties is associated with the second device.

In some examples, the signing key is associated with a blockchain wallet.

In some examples, the information indicative of the first public key share of the public key comprises a second public key share of the public key, and the public key verification component 835 may be configured as or otherwise support a means for verifying that the second public key share corresponds to the second decryption key share of the decryption key. In some examples, the information indicative of the first public key share of the public key comprises a second public key share of the public key, and the public key verification component 835 may be configured as or otherwise support a means for calculating a first public key share of the public key by subtracting the second public key share from the public key.

FIG. 9 shows a diagram of a system 900 including a device 905 that supports import of encrypted keys to a secure MPC system in accordance with aspects of the present disclosure. The device 905 may be an example of or include components of a device 705 as described herein. The device 905 may include components for importing of encrypted keys to a secure MPC system, such as including a client application 920, a communication interface 910, one or more antennas 915, a user interface component 925, at least one memory 930, and at least one processor 935. Each of these components may communicate, directly or indirectly, with one another (e.g., via one or more buses, communications links, communications interfaces, or any combination thereof).

The communication interface 910 may manage input and output signals for the device 905 via the antenna 915. For example, the communication interface 910 may enable the user device 905 to exchange information (e.g., input information, output information, or both) with other systems or devices, such as custodial token platform 110 (e.g., supported by one or more servers), via one or more wired or wireless communication links. The communication interface 910 may also utilize or interact with antenna 915 to support communication with other systems or devices. In some cases, the communication interface 910 may represent a physical connection or port to an external peripheral, such as a hardware wallet device. In some cases, the communication interface 910 may utilize an operating system such as iOS®, ANDROID®, MS-DOS®, MS-WINDOWS®, OS/2®, UNIX®, LINUX®, or another known operating system. The communication interface 910 may be implemented as part of the processor 935.

In some cases, the device 905 may include a single antenna 915. However, in some other cases, the device 905 may have more than one antenna 915, which may be capable of concurrently transmitting or receiving multiple wireless transmissions. The communication interface 910 may communicate bi-directionally, via the one or more antennas 915, wired, or wireless links as described herein. For example, the communication interface 910 may represent a wireless transceiver and may communicate bi-directionally with another wireless transceiver. The communication interface 910 may also include a modem to modulate the packets, to provide the modulated packets to one or more antennas 915 for transmission, and to demodulate packets received from the one or more antennas 915.

The user interface component 925 may represent a keyboard, a mouse, a touchscreen, a microphone, or a similar device or component. In some cases, a user may interact with the user interface component 925. In other cases, the user interface component 925 may operate automatically without user interaction. The user interface component 925 may display or output information such as information received from other systems or devices or information to be transmitted to other systems or devices.

The memory 930 may include RAM and ROM. The memory 930 may store computer-readable, computer-executable software including instructions that, when executed, cause at least one processor 935 to perform various functions described herein. In some cases, the memory 930 may contain, among other things, a BIOS which may control basic hardware or software operation such as the interaction with peripheral components or devices. The memory 930 may be an example of a single memory or multiple memories. For example, the user device 905 may include one or more memories 930.

The processor 935 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 935 may be configured to operate a memory array using a memory controller. In other cases, a memory controller may be integrated into the processor 935. The processor 935 may be configured to execute computer-readable instructions stored in at least one memory 930 to perform various functions (e.g., functions or tasks supporting a method and system for import of encrypted keys to a secure MPC system). Though a single processor 935 is depicted in the example of FIG. 9, it is to be understood that the user device 905 may include any quantity of one or more of processors 935 and that a group of processors 935 may collectively perform one or more functions ascribed herein to a processor, such as the processor 935. The processor 935 may be an example of a single processor or multiple processors. For example, the device 905 may include one or more processors 935.

For example, the client application 920 may be configured as or otherwise support a means for executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key. The client application 920 may be configured as or otherwise support a means for receiving information indicative of a first public key share of a public key and a result of an execution of a zero-knowledge proof from the first device. The client application 920 may be configured as or otherwise support a means for verifying that the public key is equal to a summation of the first public key share and a first product, the first product being of the second signing key share of the signing key and a generator function. The client application 920 may be configured as or otherwise support a means for verifying that the result of the execution of the zero-knowledge proof is valid such that the first public key share corresponds to a second product, the second product being of a first signing key share of the signing key and the generator function. The client application 920 may be configured as or otherwise support a means for outputting the second signing key share of the signing key to an entity based at least in part on verifying that the public key is equal to the summation and on verifying that the result of the execution of the zero-knowledge proof is valid.

By including or configuring the client application 920 in accordance with examples as described herein, the device 905 may support techniques for improved security when importing signing keys to an MPC scheme.

The client application 920 may include an application (e.g., “app”), program, software, extension, or other component which is configured to facilitate communications with a custodial token platform 110 on a server, one or more nodes of a blockchain network 105, other user devices 905, and other devices or systems. For example, the client application 920 may be an application executable on the user device 905, and the client application 920 may be configured to receive data from a custodial token platform 110, transmit data to the custodial token platform 110, process such data, and cause presentation of such data to a user via a user interface component 925. The client application 920 may be an example of a wallet application, a wallet device, or both, and may be associated with a wallet address and may access or use a private key to sign messages to facilitate transfer of crypto tokens, messages, transactions, or the like via a blockchain distributed data store.

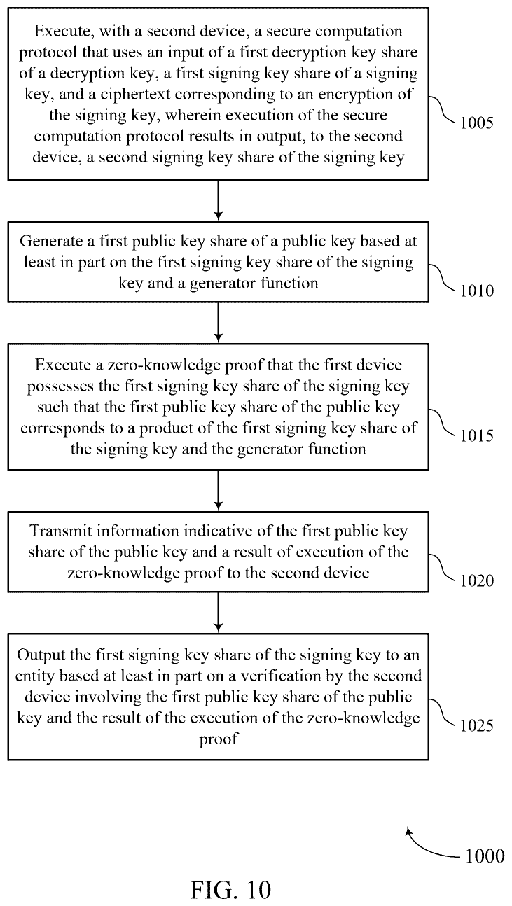

FIG. 10 shows a flowchart illustrating a method 1000 that supports import of encrypted keys to a secure MPC system in accordance with aspects of the present disclosure. The operations of the method 1000 may be implemented by a first device or its components as described herein. For example, the operations of the method 1000 may be performed by a first device as described with reference to FIGS. 1 through 6. In some examples, a first device may execute a set of instructions to control the functional elements of the first device to perform the described functions. Additionally, or alternatively, the first device may perform aspects of the described functions using special-purpose hardware.

At 1005, the method may include executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key. The operations of 1005 may be performed in accordance with examples as disclosed herein. In some examples, aspects of the operations of 1005 may be performed by a secure computation protocol component 525 as described with reference to FIG. 5.

At 1010, the method may include generating a first public key share of a public key based at least in part on the first signing key share of the signing key and a generator function. The operations of 1010 may be performed in accordance with examples as disclosed herein. In some examples, aspects of the operations of 1010 may be performed by a public key share generation component 530 as described with reference to FIG. 5.

At 1015, the method may include executing a zero-knowledge proof that the first device possesses the first signing key share of the signing key such that the first public key share of the public key corresponds to a product of the first signing key share of the signing key and the generator function. The operations of 1015 may be performed in accordance with examples as disclosed herein. In some examples, aspects of the operations of 1015 may be performed by a zero-knowledge proof component 535 as described with reference to FIG. 5.

At 1020, the method may include transmitting information indicative of the first public key share of the public key and a result of execution of the zero-knowledge proof to the second device. The operations of 1020 may be performed in accordance with examples as disclosed herein. In some examples, aspects of the operations of 1020 may be performed by a second party output component 540 as described with reference to FIG. 5.

At 1025, the method may include outputting the first signing key share of the signing key to an entity based at least in part on a verification by the second device involving the first public key share of the public key and the result of the execution of the zero-knowledge proof. The operations of 1025 may be performed in accordance with examples as disclosed herein. In some examples, aspects of the operations of 1025 may be performed by an MPC entity output component 545 as described with reference to FIG. 5.

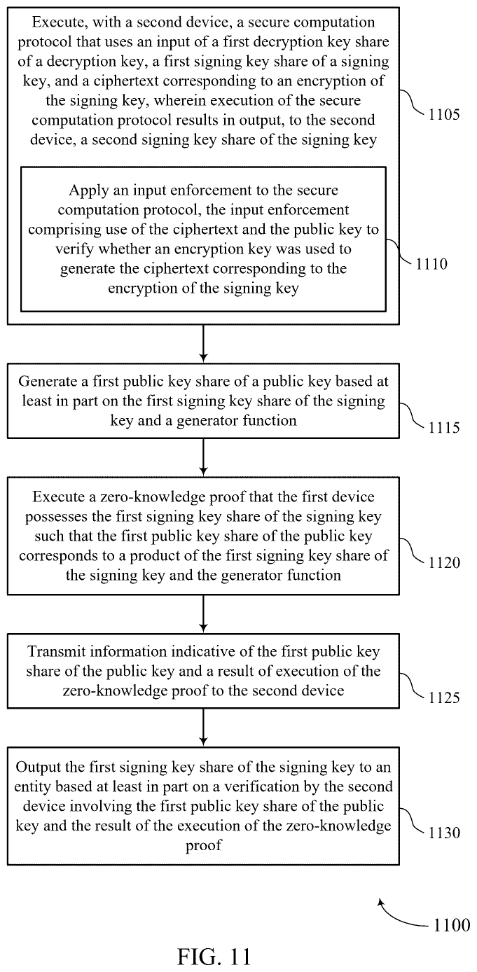

FIG. 11 shows a flowchart illustrating a method 1100 that supports import of encrypted keys to a secure MPC system in accordance with aspects of the present disclosure. The operations of the method 1100 may be implemented by a first device or its components as described herein. For example, the operations of the method 1100 may be performed by a first device as described with reference to FIGS. 1 through 6. In some examples, a first device may execute a set of instructions to control the functional elements of the first device to perform the described functions. Additionally, or alternatively, the first device may perform aspects of the described functions using special-purpose hardware.

At 1105, the method may include executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key. The operations of 1105 may be performed in accordance with examples as disclosed herein. In some examples, aspects of the operations of 1105 may be performed by a secure computation protocol component 525 as described with reference to FIG. 5.

At 1110, the method may include applying an input enforcement to the secure computation protocol, the input enforcement comprising use of the ciphertext and the public key to verify whether an encryption key was used to generate the ciphertext corresponding to the encryption of the signing key. The operations of 1110 may be performed in accordance with examples as disclosed herein. In some examples, aspects of the operations of 1110 may be performed by an input enforcement component 550 as described with reference to FIG. 5.

At 1115, the method may include generating a first public key share of a public key based at least in part on the first signing key share of the signing key and a generator function. The operations of 1115 may be performed in accordance with examples as disclosed herein. In some examples, aspects of the operations of 1115 may be performed by a public key share generation component 530 as described with reference to FIG. 5.

At 1120, the method may include executing a zero-knowledge proof that the first device possesses the first signing key share of the signing key such that the first public key share of the public key corresponds to a product of the first signing key share of the signing key and the generator function. The operations of 1120 may be performed in accordance with examples as disclosed herein. In some examples, aspects of the operations of 1120 may be performed by a zero-knowledge proof component 535 as described with reference to FIG. 5.

At 1125, the method may include transmitting information indicative of the first public key share of the public key and a result of execution of the zero-knowledge proof to the second device. The operations of 1125 may be performed in accordance with examples as disclosed herein. In some examples, aspects of the operations of 1125 may be performed by a second party output component 540 as described with reference to FIG. 5.

At 1130, the method may include outputting the first signing key share of the signing key to an entity based at least in part on a verification by the second device involving the first public key share of the public key and the result of the execution of the zero-knowledge proof. The operations of 1130 may be performed in accordance with examples as disclosed herein. In some examples, aspects of the operations of 1130 may be performed by an MPC entity output component 545 as described with reference to FIG. 5.

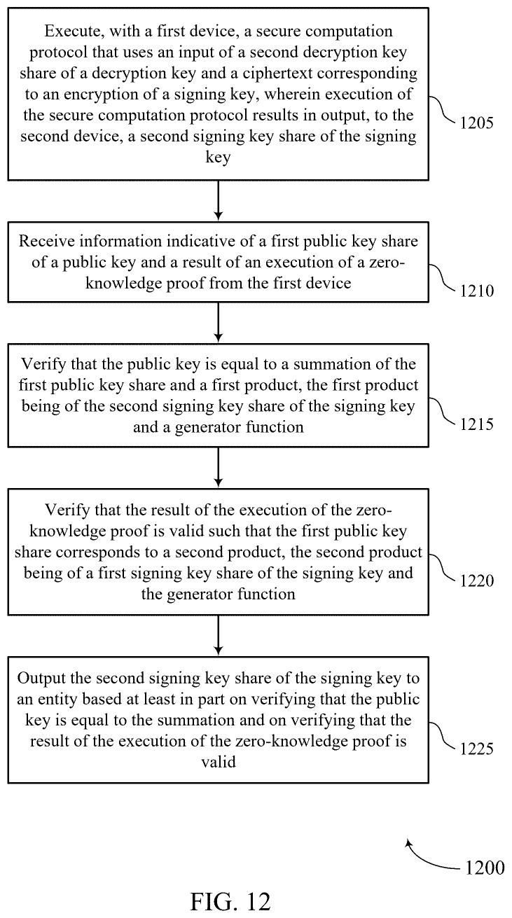

FIG. 12 shows a flowchart illustrating a method 1200 that supports import of encrypted keys to a secure MPC system in accordance with aspects of the present disclosure. The operations of the method 1200 may be implemented by a second device or its components as described herein. For example, the operations of the method 1200 may be performed by a second device as described with reference to FIGS. 1 through 3 and 7 through 9. In some examples, a second device may execute a set of instructions to control the functional elements of the second device to perform the described functions. Additionally, or alternatively, the second device may perform aspects of the described functions using special-purpose hardware.

At 1205, the method may include executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key. The operations of 1205 may be performed in accordance with examples as disclosed herein. In some examples, aspects of the operations of 1205 may be performed by a secure computation protocol component 825 as described with reference to FIG. 8.

At 1210, the method may include receiving information indicative of a first public key share of a public key and a result of an execution of a zero-knowledge proof from the first device. The operations of 1210 may be performed in accordance with examples as disclosed herein. In some examples, aspects of the operations of 1210 may be performed by a first party output component 830 as described with reference to FIG. 8.

At 1215, the method may include verifying that the public key is equal to a summation of the first public key share and a first product, the first product being of the second signing key share of the signing key and a generator function. The operations of 1215 may be performed in accordance with examples as disclosed herein. In some examples, aspects of the operations of 1215 may be performed by a public key verification component 835 as described with reference to FIG. 8.

At 1220, the method may include verifying that the result of the execution of the zero-knowledge proof is valid such that the first public key share corresponds to a second product, the second product being of a first signing key share of the signing key and the generator function. The operations of 1220 may be performed in accordance with examples as disclosed herein. In some examples, aspects of the operations of 1220 may be performed by a zero-knowledge proof verification component 840 as described with reference to FIG. 8.

At 1225, the method may include outputting the second signing key share of the signing key to an entity based at least in part on verifying that the public key is equal to the summation and on verifying that the result of the execution of the zero-knowledge proof is valid. The operations of 1225 may be performed in accordance with examples as disclosed herein. In some examples, aspects of the operations of 1225 may be performed by an MPC entity output component 845 as described with reference to FIG. 8.

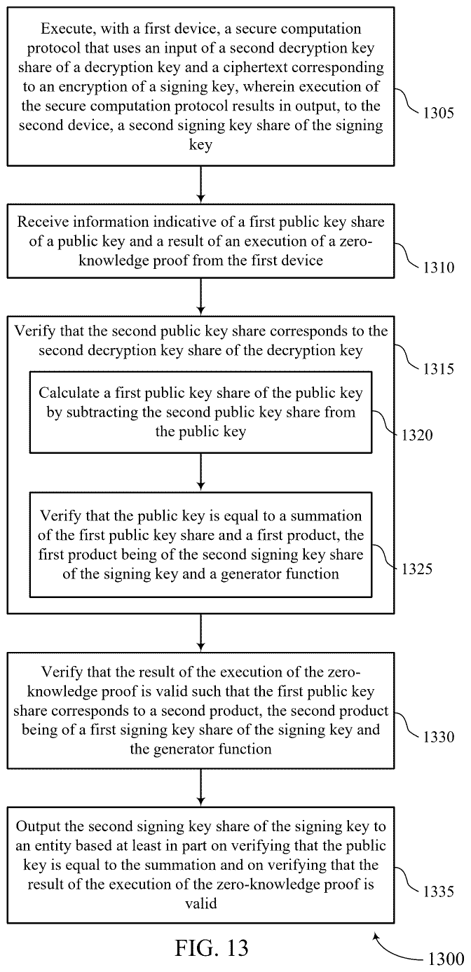

FIG. 13 shows a flowchart illustrating a method 1300 that supports import of encrypted keys to a secure MPC system in accordance with aspects of the present disclosure. The operations of the method 1300 may be implemented by a second device or its components as described herein. For example, the operations of the method 1300 may be performed by a second device as described with reference to FIGS. 1 through 3 and 7 through 9. In some examples, a second device may execute a set of instructions to control the functional elements of the second device to perform the described functions. Additionally, or alternatively, the second device may perform aspects of the described functions using special-purpose hardware.

At 1305, the method may include executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key. The operations of 1305 may be performed in accordance with examples as disclosed herein. In some examples, aspects of the operations of 1305 may be performed by a secure computation protocol component 825 as described with reference to FIG. 8.

At 1310, the method may include receiving information indicative of a first public key share of a public key and a result of an execution of a zero-knowledge proof from the first device. The operations of 1310 may be performed in accordance with examples as disclosed herein. In some examples, aspects of the operations of 1310 may be performed by a first party output component 830 as described with reference to FIG. 8.

At 1315, the method may include verifying that the second public key share corresponds to the second decryption key share of the decryption key. The operations of 1315 may be performed in accordance with examples as disclosed herein. In some examples, aspects of the operations of 1315 may be performed by a public key verification component 835 as described with reference to FIG. 8.

At 1320, the method may include calculating a first public key share of the public key by subtracting the second public key share from the public key. The operations of 1320 may be performed in accordance with examples as disclosed herein. In some examples, aspects of the operations of 1320 may be performed by a public key verification component 835 as described with reference to FIG. 8.

At 1325, the method may include verifying that the public key is equal to a summation of the first public key share and a first product, the first product being of the second signing key share of the signing key and a generator function. The operations of 1325 may be performed in accordance with examples as disclosed herein. In some examples, aspects of the operations of 1325 may be performed by a public key verification component 835 as described with reference to FIG. 8.

At 1330, the method may include verifying that the result of the execution of the zero-knowledge proof is valid such that the first public key share corresponds to a second product, the second product being of a first signing key share of the signing key and the generator function. The operations of 1330 may be performed in accordance with examples as disclosed herein. In some examples, aspects of the operations of 1330 may be performed by a zero-knowledge proof verification component 840 as described with reference to FIG. 8.

At 1335, the method may include outputting the second signing key share of the signing key to an entity based at least in part on verifying that the public key is equal to the summation and on verifying that the result of the execution of the zero-knowledge proof is valid. The operations of 1335 may be performed in accordance with examples as disclosed herein. In some examples, aspects of the operations of 1335 may be performed by an MPC entity output component 845 as described with reference to FIG. 8.

A method by a first device is described. The method may include executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key, generating a first public key share of a public key based at least in part on the first signing key share of the signing key and a generator function, executing a zero-knowledge proof that the first device possesses the first signing key share of the signing key such that the first public key share of the public key corresponds to a product of the first signing key share of the signing key and the generator function, transmitting information indicative of the first public key share of the public key and a result of execution of the zero-knowledge proof to the second device, and outputting the first signing key share of the signing key to an entity based at least in part on a verification by the second device involving the first public key share of the public key and the result of the execution of the zero-knowledge proof.

A first device is described. The first device may include one or more memories storing processor executable code, and one or more processors coupled with the one or more memories. The one or more processors may individually or collectively be operable to execute the code to cause the first device to execute, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key, generate a first public key share of a public key based at least in part on the first signing key share of the signing key and a generator function, execute a zero-knowledge proof that the first device possesses the first signing key share of the signing key such that the first public key share of the public key corresponds to a product of the first signing key share of the signing key and the generator function, transmit information indicative of the first public key share of the public key and a result of execution of the zero-knowledge proof to the second device, and output the first signing key share of the signing key to an entity based at least in part on a verification by the second device involving the first public key share of the public key and the result of the execution of the zero-knowledge proof.

Another first device is described. The first device may include means for executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key, means for generating a first public key share of a public key based at least in part on the first signing key share of the signing key and a generator function, means for executing a zero-knowledge proof that the first device possesses the first signing key share of the signing key such that the first public key share of the public key corresponds to a product of the first signing key share of the signing key and the generator function, means for transmitting information indicative of the first public key share of the public key and a result of execution of the zero-knowledge proof to the second device, and means for outputting the first signing key share of the signing key to an entity based at least in part on a verification by the second device involving the first public key share of the public key and the result of the execution of the zero-knowledge proof.

A non-transitory computer-readable medium storing code is described. The code may include instructions executable by one or more processors to execute, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key, generate a first public key share of a public key based at least in part on the first signing key share of the signing key and a generator function, execute a zero-knowledge proof that the first device possesses the first signing key share of the signing key such that the first public key share of the public key corresponds to a product of the first signing key share of the signing key and the generator function, transmit information indicative of the first public key share of the public key and a result of execution of the zero-knowledge proof to the second device, and output the first signing key share of the signing key to an entity based at least in part on a verification by the second device involving the first public key share of the public key and the result of the execution of the zero-knowledge proof.

In some examples of the method, first devices, and non-transitory computer-readable medium described herein, the secure computation protocol comprises a garbled circuit.

Some examples of the method, first devices, and non-transitory computer-readable medium described herein may further include operations, features, means, or instructions for applying an input enforcement to the secure computation protocol, the input enforcement comprising use of the ciphertext and the public key to verify whether an encryption key was used to generate the ciphertext corresponding to the encryption of the signing key.

In some examples of the method, first devices, and non-transitory computer-readable medium described herein, the ciphertext comprises a first ciphertext share associated with the first device and a second ciphertext share associated with the second device.

In some examples of the method, first devices, and non-transitory computer-readable medium described herein, the secure computation protocol may be secure against the second device that may be to receive the second signing key share.

In some examples of the method, first devices, and non-transitory computer-readable medium described herein, the secure computation protocol involves two parties and a first party of the two parties may be associated with the first device and a second party of the two parties may be associated with the second device.

In some examples of the method, first devices, and non-transitory computer-readable medium described herein, the signing key may be associated with a blockchain wallet.

In some examples of the method, first devices, and non-transitory computer-readable medium described herein, the information indicative of the first public key share of the public key comprises the first public key share or a second public key share of the public key, the public key comprising the first public key share and the second public key share.

A method by a second device is described. The method may include executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key, receiving information indicative of a first public key share of a public key and a result of an execution of a zero-knowledge proof from the first device, verifying that the public key is equal to a summation of the first public key share and a first product, the first product being of the second signing key share of the signing key and a generator function, verifying that the result of the execution of the zero-knowledge proof is valid such that the first public key share corresponds to a second product, the second product being of a first signing key share of the signing key and the generator function, and outputting the second signing key share of the signing key to an entity based at least in part on verifying that the public key is equal to the summation and on verifying that the result of the execution of the zero-knowledge proof is valid.

A second device is described. The second device may include one or more memories storing processor executable code, and one or more processors coupled with the one or more memories. The one or more processors may individually or collectively be operable to execute the code to cause the second device to execute, with a first device, a secure computation protocol that uses an input of a second decryption key share of a decryption key and a ciphertext corresponding to an encryption of a signing key, wherein execution of the secure computation protocol results in output, to the second device, a second signing key share of the signing key, receive information indicative of a first public key share of a public key and a result of an execution of a zero-knowledge proof from the first device, verify that the public key is equal to a summation of the first public key share and a first product, the first product being of the second signing key share of the signing key and a generator function, verify that the result of the execution of the zero-knowledge proof is valid such that the first public key share corresponds to a second product, the second product being of a first signing key share of the signing key and the generator function, and output the second signing key share of the signing key to an entity based at least in part on verifying that the public key is equal to the summation and on verifying that the result of the execution of the zero-knowledge proof is valid.

Another second device is described. The second device may include means for executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key, means for receiving information indicative of a first public key share of a public key and a result of an execution of a zero-knowledge proof from the first device, means for verifying that the public key is equal to a summation of the first public key share and a first product, the first product being of the second signing key share of the signing key and a generator function, means for verifying that the result of the execution of the zero-knowledge proof is valid such that the first public key share corresponds to a second product, the second product being of a first signing key share of the signing key and the generator function, and means for outputting the second signing key share of the signing key to an entity based at least in part on verifying that the public key is equal to the summation and on verifying that the result of the execution of the zero-knowledge proof is valid.

A non-transitory computer-readable medium storing code is described. The code may include instructions executable by one or more processors to execute, with a first device, a secure computation protocol that uses an input of a second decryption key share of a decryption key and a ciphertext corresponding to an encryption of a signing key, wherein execution of the secure computation protocol results in output, to the second device, a second signing key share of the signing key, receive information indicative of a first public key share of a public key and a result of an execution of a zero-knowledge proof from the first device, verify that the public key is equal to a summation of the first public key share and a first product, the first product being of the second signing key share of the signing key and a generator function, verify that the result of the execution of the zero-knowledge proof is valid such that the first public key share corresponds to a second product, the second product being of a first signing key share of the signing key and the generator function, and output the second signing key share of the signing key to an entity based at least in part on verifying that the public key is equal to the summation and on verifying that the result of the execution of the zero-knowledge proof is valid.

In some examples of the method, second devices, and non-transitory computer-readable medium described herein, the secure computation protocol comprises a garbled circuit.

Some examples of the method, second devices, and non-transitory computer-readable medium described herein may further include operations, features, means, or instructions for applying an input enforcement to the secure computation protocol, the input enforcement comprising use of the ciphertext and the public key to verify whether an encryption key was used to generate the ciphertext corresponding to the encryption of the signing key.

In some examples of the method, second devices, and non-transitory computer-readable medium described herein, the ciphertext comprises a first ciphertext share associated with the first device and a second ciphertext share associated with the second device.

In some examples of the method, second devices, and non-transitory computer-readable medium described herein, the execution of the secure computation protocol does not reveal any information about the second decryption key share of the decryption key or the second signing key share of the signing key to the first device.

In some examples of the method, second devices, and non-transitory computer-readable medium described herein, the secure computation protocol involves two parties and a first party of the two parties may be associated with the first device and a second party of the two parties may be associated with the second device.

In some examples of the method, second devices, and non-transitory computer-readable medium described herein, the signing key may be associated with a blockchain wallet.

In some examples of the method, second devices, and non-transitory computer-readable medium described herein, the information indicative of the first public key share of the public key comprises a second public key share of the public key and the method, apparatuses, and non-transitory computer-readable medium may include further operations, features, means, or instructions for verifying that the second public key share corresponds to the second decryption key share of the decryption key and calculating a first public key share of the public key by subtracting the second public key share from the public key.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method at a first device, comprising:
executing, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key;
generating a first public key share of a public key based at least in part on the first signing key share of the signing key and a generator function;
executing a zero-knowledge proof that the first device possesses the first signing key share of the signing key such that the first public key share of the public key corresponds to a product of the first signing key share of the signing key and the generator function;
transmitting information indicative of the first public key share of the public key and a result of execution of the zero-knowledge proof to the second device; and
outputting the first signing key share of the signing key to an entity based at least in part on a verification by the second device involving the first public key share of the public key and the result of the execution of the zero-knowledge proof.

2. The method of claim 1, wherein the secure computation protocol comprises a garbled circuit.

3. The method of claim 1, further comprising:
applying an input enforcement to the secure computation protocol, the input enforcement comprising use of the ciphertext and the public key to verify whether an encryption key was used to generate the ciphertext corresponding to the encryption of the signing key.

4. The method of claim 1, wherein the ciphertext comprises a first ciphertext share associated with the first device and a second ciphertext share associated with the second device.

5. The method of claim 1, wherein the secure computation protocol is secure against the second device that is to receive the second signing key share.

6. The method of claim 1, wherein the secure computation protocol involves two parties, and wherein a first party of the two parties is associated with the first device and a second party of the two parties is associated with the second device.

7. The method of claim 1, wherein the signing key is associated with a blockchain wallet.

8. The method of claim 1, wherein the information indicative of the first public key share of the public key comprises the first public key share or a second public key share of the public key, the public key comprising the first public key share and the second public key share.

9. A method at a second device, comprising:
executing, with a first device, a secure computation protocol that uses an input of a second decryption key share of a decryption key and a ciphertext corresponding to an encryption of a signing key, wherein execution of the secure computation protocol results in output, to the second device, a second signing key share of the signing key;
receiving information indicative of a first public key share of a public key and a result of an execution of a zero-knowledge proof from the first device;
verifying that the public key is equal to a summation of the first public key share and a first product, the first product being of the second signing key share of the signing key and a generator function;
verifying that the result of the execution of the zero-knowledge proof is valid such that the first public key share corresponds to a second product, the second product being of a first signing key share of the signing key and the generator function; and
outputting the second signing key share of the signing key to an entity based at least in part on verifying that the public key is equal to the summation and on verifying that the result of the execution of the zero-knowledge proof is valid.

10. The method of claim 9, wherein the secure computation protocol comprises a garbled circuit.

11. The method of claim 9, further comprising:
applying an input enforcement to the secure computation protocol, the input enforcement comprising use of the ciphertext and the public key to verify whether an encryption key was used to generate the ciphertext corresponding to the encryption of the signing key.

12. The method of claim 9, wherein the ciphertext comprises a first ciphertext share associated with the first device and a second ciphertext share associated with the second device.

13. The method of claim 9, wherein the execution of the secure computation protocol does not reveal any information about the second decryption key share of the decryption key or the second signing key share of the signing key to the first device.

14. The method of claim 9, wherein the secure computation protocol involves two parties, and wherein a first party of the two parties is associated with the first device and a second party of the two parties is associated with the second device.

15. The method of claim 9, wherein the signing key is associated with a blockchain wallet.

16. The method of claim 9, wherein the information indicative of the first public key share of the public key comprises a second public key share of the public key, the method further comprising:
verifying that the second public key share corresponds to the second decryption key share of the decryption key; and
calculating a first public key share of the public key by subtracting the second public key share from the public key.

17. A first device, comprising:
one or more memories storing processor-executable code; and
one or more processors coupled with the one or more memories and individually or collectively operable to execute the code to cause the first device to:
execute, with a second device, a secure computation protocol that uses an input of a first decryption key share of a decryption key, a first signing key share of a signing key, and a ciphertext corresponding to an encryption of the signing key, wherein execution of the secure computation protocol results in output, to the second device, a second signing key share of the signing key;
generate a first public key share of a public key based at least in part on the first signing key share of the signing key and a generator function;
execute a zero-knowledge proof that the first device possesses the first signing key share of the signing key such that the first public key share of the public key corresponds to a product of the first signing key share of the signing key and the generator function;
transmit information indicative of the first public key share of the public key and a result of execution of the zero-knowledge proof to the second device; and
output the first signing key share of the signing key to an entity based at least in part on a verification by the second device involving the first public key share of the public key and the result of the execution of the zero-knowledge proof.

18. The first device of claim 17, wherein the secure computation protocol comprises a garbled circuit.

19. The first device of claim 17, wherein the one or more processors are individually or collectively further operable to execute the code to cause the first device to:
apply an input enforcement to the secure computation protocol, the input enforcement comprising use of the ciphertext and the public key to verify whether an encryption key was used to generate the ciphertext corresponding to the encryption of the signing key.

20. The first device of claim 17, wherein the ciphertext comprises a first ciphertext share associated with the first device and a second ciphertext share associated with the second device.
